(19) United States
(12) Patent Application Publication
(10) Pub. No.: US 2026/0367225 A1
(43) Pub. Date: Nov. 19, 2026

(54) DUAL-PORT OPTICAL TRANSCEIVER AND RELATED LIDAR SYSTEM

(71) Applicant: Lumos Infinitas USA Inc., Irvine, CA (US)

(72) Inventors: Babak BAHARI, Irvine, CA (US); Dachuan WU, Aliso Viejo, CA (US); Dawei ZHENG, Irvine, CA (US)

(73) Assignee: Lumos Infinitas USA Inc., Irvine, CA (US)

(21) Appl. No.: 19/211,050

(22) Filed: May 16, 2025

(51) Int. Cl. G01S 7/481; G01S 7/4865

(52) U.S. Cl. CPC G01S 7/4812; G01S 7/4818; G01S 7/4865

(57) ABSTRACT

A dual-port optical transceiver for a light detection and ranging (LiDAR) systems, which eliminates the need for optical circulators or polarization beam splitter rotator (PBSR) by employing two dedicated waveguides, one for light signal transmission and one for reception. The two parallel waveguides are separated by an optimal separation distance. By separating the optical paths of the transmitted (Tx) and received (Rx) light signal, this system significantly reduces system complexity, minimizes insertion loss, and enhances signal integrity, leading to improved overall performance. The LiDAR system further includes a power beam slitter that generates a local oscillator (LO) signal and the Rx signal, a 2×2 multi-mode interferometer or directional coupler for mixing the LO signal with the Rx signal, and a balanced photodiode for detecting the mixed signal.

### BACKGROUND OF THE INVENTION

This invention relates to optical transceivers for light detection and ranging (LiDAR) systems, and in particular, it relates to an optical transceiver that separates transmitted (Tx) and received (Rx) signals without using an optical circulator or a polarization beam splitter rotator (PBSR).

LiDAR technology has undergone significant advancements, with recent developments aimed at improving accuracy, reducing system size, and lowering manufacturing costs. Conventional LiDAR systems often utilize optical circulators or polarizing beam splitter rotators (PBSR) to separate transmitted and received signals within a shared optical path. Some examples of LiDAR systems that employ optical circulators include U.S. Pat. Nos. 11,422,244, 11,422,258, and 12,066,536. While effective, these components introduce several drawbacks, including increased system complexity, higher insertion loss, and greater cost. Additionally, their integration poses challenges for miniaturization and scalability in compact and integrated photonic systems.

The reliance on circulators or PBSR presents further limitations in applications requiring high precision and reliability, such as autonomous vehicles, environmental monitoring, and 3D mapping. These components contribute to optical losses and potential signal interference, impacting overall system performance. As the demand for more efficient, scalable, and cost-effective LiDAR solutions grows, there remains a need for an improved transceiver design that eliminates the dependency on circulators or PBSR while maintaining or enhancing system functionality.

LiDAR systems are usually classified into two major types, namely, bistatic and monostatic. In a monostatic LiDAR system, the transmitter and receiver are co-located or positioned in close proximity, often within the same housing. The system operates by emitting an optical pulse that interacts with a target, and the backscattered or reflected signal is received along the same optical path or within a small angular offset. It benefits from some advantages of simplified optical alignment and system integration, high signal return efficiency due to direct backscatter detection, and compact form factors, enabling deployment in mobile platforms. However, it has increased susceptibility to specular reflections, potentially leading to signal saturation, and limited ability to analyze angular scattering characteristics.

A bistatic LiDAR system is characterized by a spatial separation between the transmitter and receiver, resulting in a nonzero angle between the emitted and detected optical paths. The receiver captures scattered light at an offset angle, enabling alternative measurement modalities. It benefits from some advantages of reduced susceptibility to direct specular reflections, enhanced capability for angular scattering analysis, facilitating material characterization, and increased flexibility in system configuration for specific sensing objectives. However, it requires precise alignment and calibration of transmitter and receiver components. Also, it suffers from data processing complexity due to angular dependence of detected signals.

In many cases monostatic LiDAR has advantages over bistatic because it uses less components in the system, thus it is less expensive, and the overall complexity of the system is reduced. Additionally, the specular reflection from a target is stronger, and it helps to increase the SNR and range a longer distance. However, separating Tx and Rx signals in a co-located port is a challenge that usually is addressed by using an optical circulator or PBSR, which can increase the system cost and complexity.

### SUMMARY OF THE INVENTION

Embodiments of the present invention provide a LiDAR system that utilizes a dual-port transceiver to eliminate the need for a circulator or a PBSR, which tends to be bulky or complex. In the dual-port transceiver according to embodiments of the present invention, two separate optical ports—one for transmission and one for reception—are placed very close to each other within an optimum spacing distance such that the coupling efficiency of transmitting (Tx) and receiving (Rx) ports are very high while the power leakage between two ports is negligible.

By separating the optical paths of the Tx and Rx ports, this system significantly reduces system complexity, minimizes insertion loss, and enhances signal integrity, leading to improved overall performance. The dual port transceiver architecture enables a more compact and efficient LiDAR system, particularly suited for integrated photonic applications in autonomous navigation, robotics, and portable 3D mapping. By simplifying the optical path and removing bulky components, the LiDAR system according to embodiments of the present invention facilitates scalable photonic integration, reduces manufacturing costs, and improves system reliability. This approach aligns with industry trends favoring miniaturized, high-performance LiDAR solutions capable of meeting the demands of modern sensing applications.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a dual-port optical transceiver for a light detection and ranging (LiDAR) system, which includes: a substrate; a first waveguide disposed on the substrate, the first waveguide having a first section with a first width, a second section with a second width smaller than the first width, and a tapering section connecting the first section and the second section, wherein an end of the second section is located on an edge of the substrate; and a second waveguide disposed on the substrate, the second waveguide having a first section with a first width, a second section with a second width smaller than the first width, and a tapering section connecting the first section and the second section, wherein an end of the second section is located on the edge of the substrate; wherein a waveguide spacing between the first waveguide and the second waveguide is between 4 μm and 20 μm. The first and second waveguides are preferably parallel to each other.

In another aspect, the present invention provides a LiDAR system, which includes: the dual-port optical transceiver described above; a light source; a power beam slitter having an input port optically coupled to the light source and a first output port optically coupled to an end of the first section of the first waveguide; a photonic mixer having a second input port optically coupled to an end of the first section of the second waveguide; a delay line optically coupled between a second output port of the power beam splitter and a first input port of the photonic mixer; and two photodetectors forming a balanced photodetector, optically coupled to two output ports of the photonic mixer.

In some embodiments, the beam slitter, the photonic mixer, and the balanced photodetector are disposed on the substrate to form a photonic integrated circuit along with the dual-port optical transceiver. The first and second waveguides may be formed of silicon, silicon nitride, or indium phosphide.

In some embodiments, the LiDAR system further includes a collimating lens optically coupled to the first ends of both the first and second waveguides, a beam steering mechanism optically coupled to the collimating lens, an amplifier electrically coupled to the balanced photodetector to generate amplified signals, and electrical processing circuitry configured to control the beam steering mechanism and process the amplified signals.

In another aspect, the present invention provides a method for operating a light detection and ranging (LiDAR) system including a dual-port optical transceiver, which includes: transmitting light through a first waveguide disposed on a substrate, wherein the first waveguide has a first section with a first width, a second section with a second width smaller than the first width, and a tapering section connecting the first section and the second section, wherein an end of the second section is located on an edge of the substrate for transmitting the light; and receiving reflected light through a second waveguide disposed on the substrate, wherein the second waveguide has a first section with a first width, a second section with a second width smaller than the first width, and a tapering section connecting the first section and the second section, wherein an end of the second section is located on the edge of the substrate for receiving the reflected light, wherein a waveguide spacing between the first waveguide and the second waveguide is between 4 μm and 20 μm.

In some embodiments, the method further includes: generating the light using a light source optically coupled to the first waveguide; detecting the received light using a photodetector optically coupled to the second waveguide; collimating the transmitted light from the end of the second section of the first waveguide using a collimating lens; focusing the reflected light into the end of second section of the second waveguide using the collimating lens, and steering the transmitted light and the reflected light using a beam steering mechanism.

In some embodiments, the method further includes: measuring a time-of-flight between the transmitted and received light pulses, or a modulated frequency shift between the transmitted and received continuous wave light; calculating distance information based on the measured time-of-flight or the modulated frequency shift; analyzing the received light to generate intensity information; and generating a three-dimensional point cloud based on the distance and intensity information.

In another aspect, the present invention provides a method for manufacturing a LiDAR system including a dual-port optical transceiver, which includes: forming a first waveguide on a substrate, the first waveguide having a first section with a first width, a second section with a second width smaller than the first width, and a tapering section connecting the first section and the second section, wherein an end of the second section is located on an edge of the substrate; and forming a second waveguide on the substrate, the second waveguide having a first section with a first width, a second section with a second width smaller than the first width, and a tapering section connecting the first section and the second section, wherein an end of the second section is located on the edge of the substrate, wherein a waveguide spacing between the first waveguide and the second waveguide is between 4 μm and 20 μm. The first and second waveguides are preferably parallel to each other.

In some embodiments, the method further includes: providing a light source; forming a power beam slitter having an input port optically coupled to the light source and a first output port optically coupled to an end of the first section of the first waveguide; forming a photonic mixer having a first input port optically coupled to an end of the first section of the second waveguide; forming a delay line optically coupled between a second output port of the power beam splitter and a second input port of the photonic mixer; and forming a balanced photodetector including two photodetectors, optically coupled to two output ports of the photonic mixer.

It is to be understood that both the foregoing general description and the following detailed description are exemplary and explanatory and are intended to provide further explanation of the invention as claimed.

### BRIEF DESCRIPTION OF DRAWINGS

FIG. 1 schematically illustrates a dual-port optical transceiver for a LiDAR system according to embodiments of the present invention.

FIG. 2 schematically illustrates a conventional monostatic LiDAR system using a single port optical transceiver (coaxial system).

FIG. 3 shows a point cloud generated by a conventional coaxial LiDAR system such as that shown in FIG. 2.

FIG. 4 schematically illustrates a LiDAR system using a dual-port optical transceiver according to embodiments of the present invention.

FIG. 5 schematically illustrates the waveguides of the dual-port optical transceiver with different waveguide spacings according to embodiments of the present invention.

FIG. 6 shows point clouds generated by the LiDAR system using dual-port optical transceivers of different waveguide spacings in the system shown in FIGS. 4 and 5.

FIGS. 7 and 8 show comparisons of the point cloud amplitude generated by the LiDAR system using dual-port optical transceivers shown in FIGS. 4 and 5 and by the coaxial LiDAR system shown in FIG. 2.

### DETAILED DESCRIPTION OF THE INVENTION

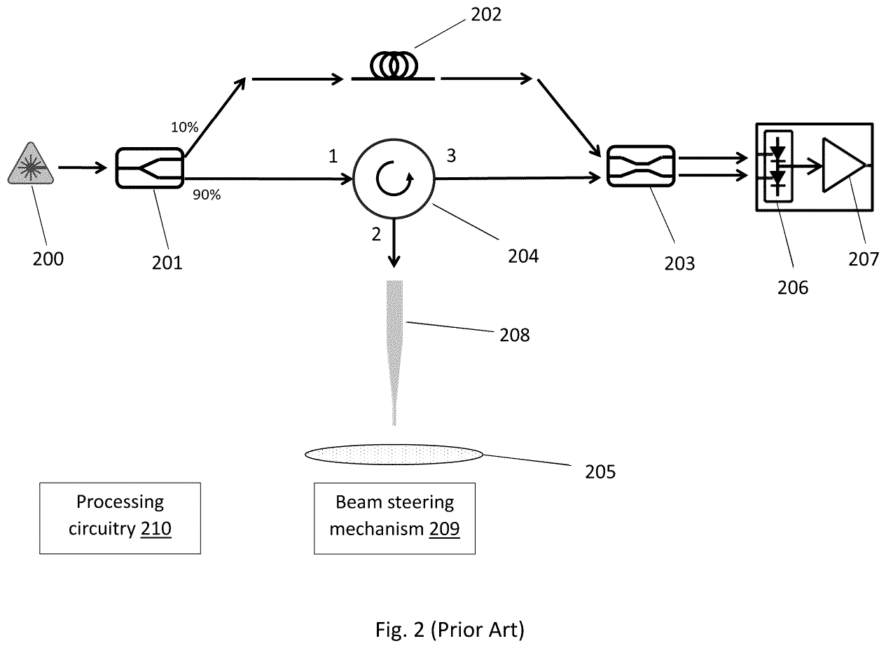

FIG. 2 shows a conventional monostatic LiDAR system using a single port optical transceiver (coaxial system). A laser 200 generates light with a given frequency and power. The light is coupled into a PIC (photonic integrated circuit) chip, and is then split into two parts by a power beam splitter 201. One part has a smaller portion (e.g. 10%) of the power, which is used as a local oscillator (LO) signal, and the other part has a larger portion (e.g. 90%) of the power, which is used for transmitting into space (Tx signal). The LO portion propagates through a long delay line 202, which may be a long optical fiber or spiral waveguide. Then it is coupled to a first input port of a 2×2 multi-mode interferometer (MMI) or directional coupler 203 (generally referred to as a photonic mixer). The Tx signal is coupled into a three-port optical circulator device 204. The three-port optical circulator is a device that transmits signals input into its first port to be output to its second port, and transmits signals input into its second port to be output to its third port. Here, the Tx signal enters the first port (port 1) of the optical circulator 204 and is output to a second port (port 2) of the optical circulator, and the received light signal (Rx) coming back into the second port (port 2) will be coupled to the third port (port 3).

The Tx signal output from port 2 of the optical circulator 204 is coupled to a narrow waveguide 208 which transmits it into the space. An optical lens 205 is provided for collimating the light signal being transmitted into the space. A beam steering mechanism 209, which may include a scanning mirror, is provided to steer the light signal in space.

The transmitted light is reflected by the target back to the LiDAR as the returned light. It is reflected by the beam steering mechanism and focused by the lens 205, and coupled into the waveguide 208 as the received signal (Rx signal), traveling in the opposite direction as the Tx signal, then propagates into port 2 of the optical circulator 204 and exits from port 3 of the optical circulator. The Rx signal is then coupled to a second input port of the 2×2 MMI or directional coupler 203. The LO and Rx signals are mixed in the 2×2 MMI or directional coupler 203. The two outputs from the two output ports of the MMI or directional coupler 203 are respectively coupled to two photodetectors that are connected so as to form a balanced photodiode 206. The output electrical signal of the balanced photodiode 206 is coupled to an amplifier 207 which amplifies it. Electrical processing circuitry 210 is provided to control the light source and the beam steering mechanism, and to process the electrical signals from the amplifier to generate information representing the distances of the points on the target.

In the LiDAR system of FIG. 2, the beam splitter 201, the delay line 202, the optical circulator 204, the waveguide 208, the MMI or directional coupler 203, and the balanced photodiode 206 may be formed on the PIC chip. The PIC chip generally includes a substrate with the various components fabricated thereon. The waveguide 208 may be formed of silicon, silicon nitride, or indium phosphide. Fabrication techniques for the PIC chip of the LiDAR system are generally known.

The operation method of the LiDAR system of FIG. 2 is generally known. It generally includes the following steps. A pulsed or continuous wave light beam is transmitted to the space through the waveguide 208. The transmitted light is collimated by the lens 205 and steered by the beam steering mechanism 209 toward the target. The reflected light from the target is focused by the lens 205 and reflected by the beam steering mechanism 209, and received by the same waveguide 208. The received light is mixed with the delayed LO signal by the MMI or directional coupler 203, the output of which is detected by the balanced photodiode 206. The time-of-flight between the transmitted and received light pulses, or modulated frequency shift between the transmitted and received continuous wave light, is measured based on the output of the balanced photodiode 206. The distance information regarding the target is then calculated based on the measured time-of-flight or the modulated frequency shift between the transmitted and received signals. Further, the received light signal may be analyzed for intensity information, and a point cloud (a three-dimensional dataset, where the (x, y) positions are determined by the steering angles of the beam steering mechanism) may be generated based on the distance and intensity information. The data processing may be performed by the processing circuitry 210. The data processing method outlined above is generally known.

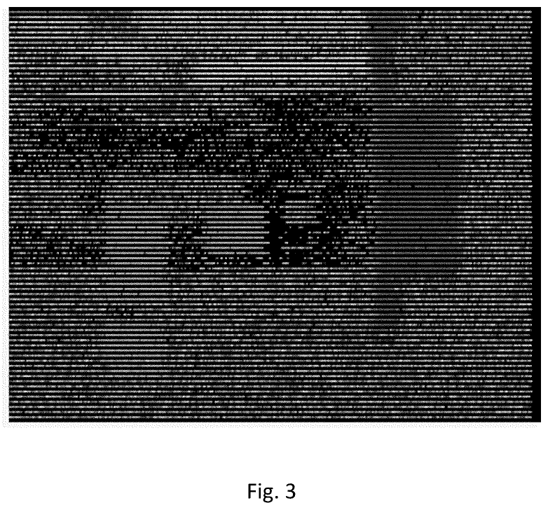

FIG. 3 shows an exemplary point cloud generated by a coaxial LiDAR system such as that shown in FIG. 2.

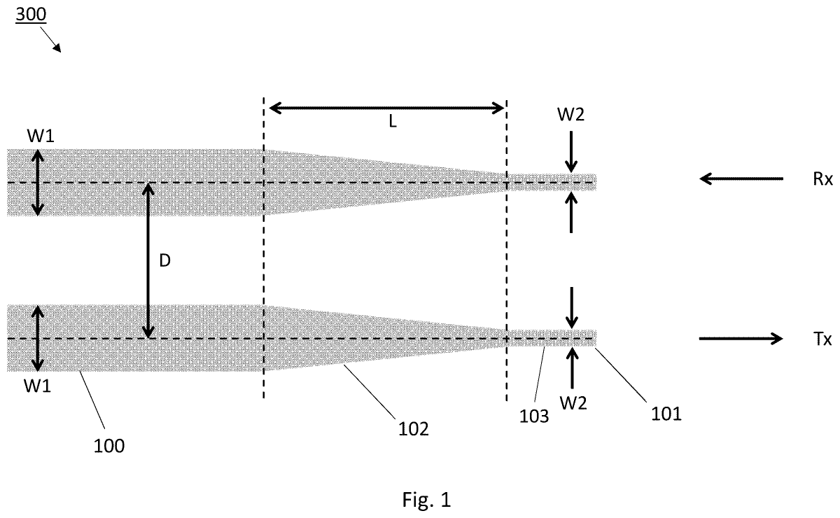

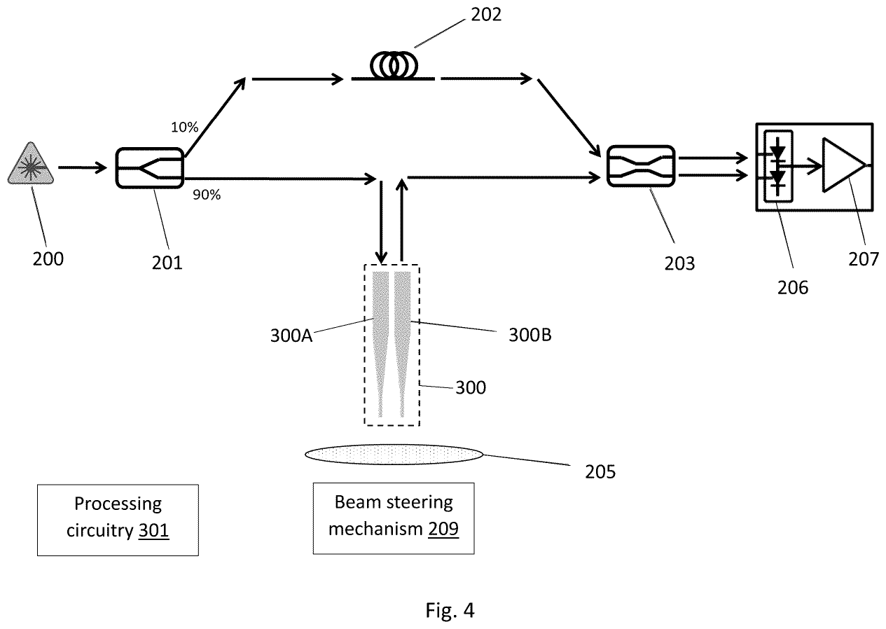

FIG. 4 shows a LiDAR system using a dual-port optical transceiver according to embodiments of the present invention. The LiDAR system in FIG. 4 is similar to that shown in FIG. 2 in some aspects but does not use an optical circulator, and employs a dual-port transceiver 300, details of which are schematically illustrated in FIG. 1 and will be described in more detail later.

In the LiDAR system of FIG. 4, a laser 200 generates light with a given frequency and power. The light is coupled into a PIC chip, and is then input into the input port of a power beam splitter 201 which splits the light into two parts at its two output ports. One part has a smaller portion (e.g. 10%) of the power, which is used as a local oscillator (LO) signal, and the other part has a larger portion (e.g. 90%) of the power, which is used for transmitting into space (Tx signal). The LO portion propagates through a long delay line 202, which may be a long optical fiber or spiral waveguide. Then it is coupled to a first input port of a 2×2 multi-mode interferometer (MMI) or directional coupler 203 (more generally, a photonic mixer). The Tx signal is coupled directly (without going through an optical circulator or PBSR) into the dual-port transceiver 300. The Tx light enters one of the waveguides 300A (the Tx port) of the dual-port transceiver 300 which transmits it into the space. An optical lens 205 is provided for collimating the light signal being transmitted into the space. A beam steering mechanism 209, which may include a scanning mirror, is provided to steer the light signal in space.

The transmitted light is reflected by the target back to the LiDAR as the returned light. It is reflected by the beam steering mechanism and focused by the lens 205, and coupled into the other one of the waveguides 300B (the Rx port) of the dual-port transceiver 300 as the received signal (Rx signal). After exiting the waveguide 300B, the Rx signal is coupled directly (without going through an optical circulator or PBSR) to a second input port of the 2×2 MMI or directional coupler 203. The LO and Rx signals are mixed in the 2×2 MMI or directional coupler 203. The two outputs from the two output ports of the MMI or directional coupler 203 are respectively coupled to two photodetectors that are connected so as to form a balanced photodiode 206. The output electrical signal of the balanced photodiode 206 is coupled to an amplifier 207 which amplifies it. Electrical processing circuitry 301 is provided to control the light source and the beam steering mechanism, and to process the electrical signals from the amplifier to generate information representing the distances of the points on the target.

In the LiDAR system of FIG. 4, the beam splitter 201, the delay line 202, the dual-port transceiver 300, the MMI or directional coupler 203, and the balanced photodiode 206 may be formed on the PIC chip. The PIC chip generally includes a substrate with the various components fabricated thereon. The waveguides of the dual-port optical transceiver 300 may be formed of silicon, silicon nitride, or indium phosphide. Any suitable techniques may be used to fabricate the PIC chip.

The operation method of the LiDAR system of FIG. 4 includes the following steps. A pulsed or continuous wave light beam is transmitted to the space through the Tx port 300A of the dual-port transceiver. The transmitted light is collimated by the lens 205 and steered by the beam steering mechanism 209 toward the target. The reflected light from the target is focused by the lens 205 and reflected by the beam steering mechanism 209, and received by the Rx port 300B of the dual-port transceiver. The received light is mixed with the delayed LO signal by the MMI or directional coupler 203, the output of which is detected by the balanced photodiode 206. The time-of-flight between the transmitted and received light pulses, or modulated frequency shift between the transmitted and received continuous wave light, is measured based on the output of the balanced photodiode 206. The distance information regarding the target is then calculated based on the measured time-of-flight or the modulated frequency shift between the transmitted and received signals. Further, the received light signal may be analyzed for intensity information, and a three-dimensional point cloud may be generated based on the distance and intensity information. The data processing may be performed by the processing circuitry 301, which may be implemented by logic circuits and/or processors which execute computer executable program code stored in computer readable non-volatile memories.

FIG. 1 shows details of the dual-port optical transceiver 300 used in the LiDAR system according to embodiments of the present invention. The dual-port transceiver 300 includes two parallel straight waveguides, one for transmitting light to space (Tx port), and the other for receiving light from space (Rx port). The two waveguides are preferably identical in shape and size. The transmitting and receiving ends 101 of the two waveguides are located at the edge of the PIC chip. As the two waveguides approach this edge of the PIC chip, their widths are gradually reduced over a tapering length L (tapering section 102), and both become narrow (the narrower waveguide sections 103). By narrowing the waveguides, the optical mode can easily radiate out of the transmitter waveguide with a very low coupling loss, and the received light from space can couple into the receiver waveguide with almost no power leakage between Tx and Rx ports. The transition parts (tapering sections) 102 are designed such that almost all the optical signal propagates from the wider waveguide sections 100 to the narrower waveguide sections 103 and vice versa. The wider waveguide sections 100 of the Tx and Rx waveguides are respectively coupled to the power beam splitter 201 and the 2×2 MMI or directional coupler 203, as shown in FIG. 4.

An important parameter of the dual-port transceiver 300 to be optimized is the waveguide spacing, i.e. the center-to-center spacing D between the two waveguides. As for the other parameters, the width W1 of the wider sections 100 may be a typical width of optical transceiver waveguides, e.g., about 400-500 nm for single mode Si waveguides and about 700-1000 nm for single mode SiN waveguides, although other values may be used as well. The width W2 of the narrow sections 103 should be as small as possible, but is generally limited by fabrication techniques to about 100 nm for Si waveguides and 150 nm for SiN waveguides. The tapering length L of the tapering section 102 is preferably 100-300 microns or longer for both Si and SiN waveguides, and the minimum length may depend on the waveguide fabrication platform and the other dimensions of the waveguides. Generally speaking, longer tapering lengths are preferred for achieving lower optical losses, because shorter tapering length tends to increase optical back reflection, but the upper limit of the tapering length is constrained by practical considerations.

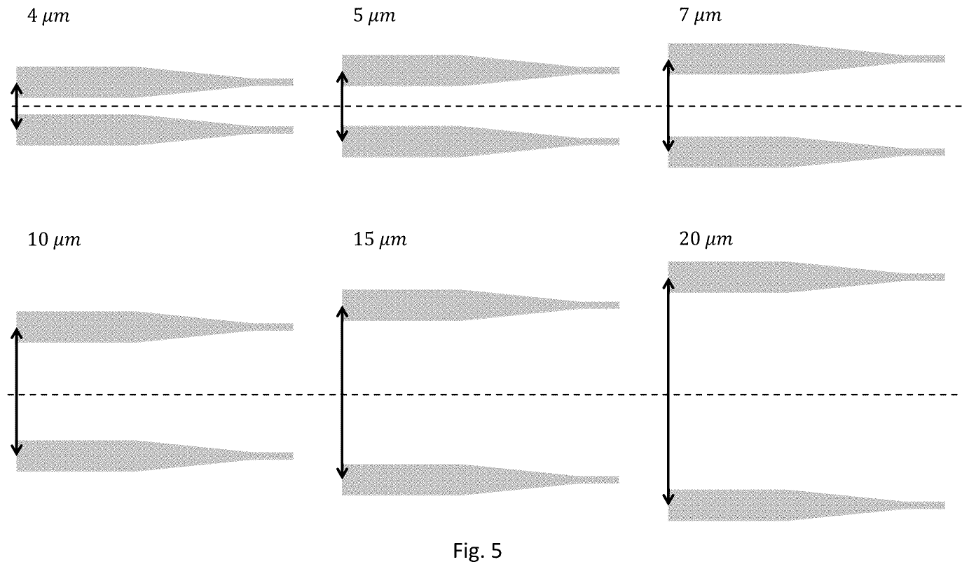

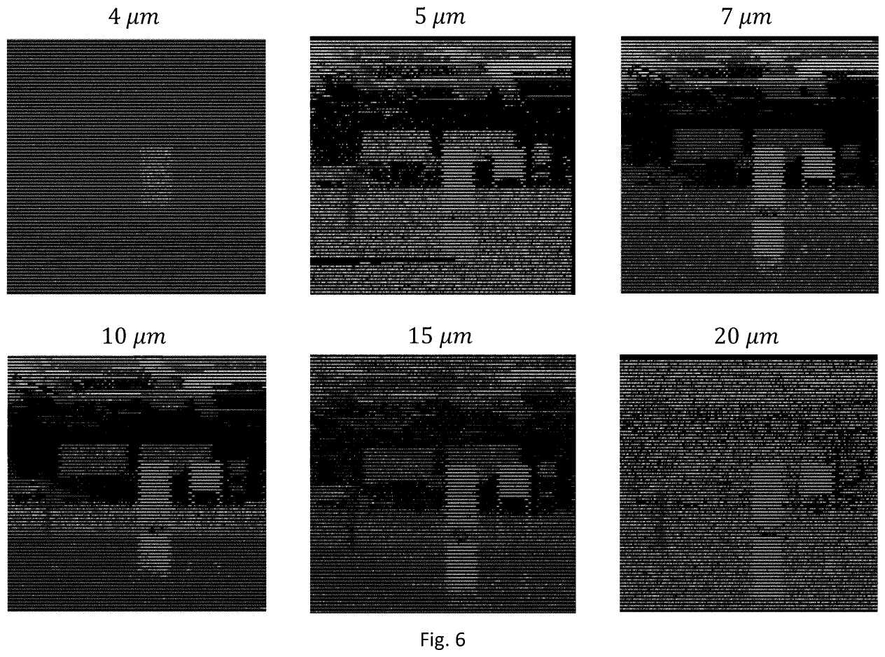

The inventors have experimented with optimizing the waveguide spacing D by constructing LiDAR systems using various parameter values and measuring the point clouds generated by the systems. FIG. 5 depicts the waveguides of the dual-port optical transceiver with different waveguide spacing D, more specifically, for 4 μm, 5 μm, 7 μm, 10 μm, 15 μm, and 20 μm spacings. FIG. 6 shows the resulting point clouds that are generated by the LiDAR system using the dual port optical transceiver with the above-listed waveguide spacings, respectively.

In addition to the waveguide spacing D noted in the drawings, the other parameters used for the dual-port optical transceiver in the above experiments were: W1=700 nm, W2=150 nm, and L=300 μm, using SiN waveguides with a thickness of 400 nm.

From the experimental results, it can be seen that when the waveguide spacing D is too small (e.g., 4 μm), the two waveguide ports are signal-coupled to each other, and the signal-to-noise ratio is relatively low and the point cloud image is not clear. On the other hand, when the waveguide spacing D is too large (e.g., 15 or 20 μm), although the two waveguide ports are completely decoupled, the Rx port—where the return signal is received—is spatially too far from the Tx port, resulting in relatively weak Rx signals, and the point cloud images are not sufficiently clear. When the waveguide spacing D is between 5 to 10 μm, two waveguides are sufficiently decoupled and do not interfere with each other, and the Rx signal is not too weak; therefore, the point cloud images are clear with high signal-to-noise ratios.

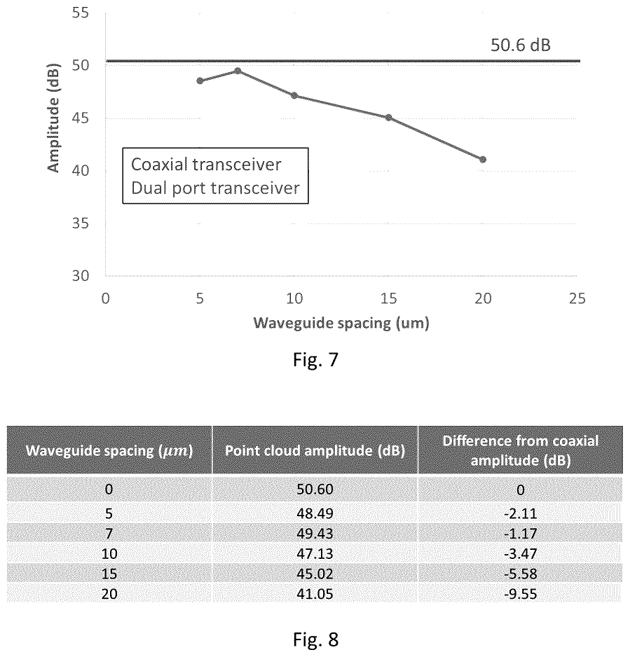

FIG. 7 (graph) and FIG. 8 (table) show the comparison of the point cloud amplitude generated by the above dual-port LiDAR systems compared to that of the coaxial LiDAR system shown in FIG. 2 (the corresponding point cloud is shown in FIG. 3), which has only one waveguide port for Tx and Rx (represented by D=0 in the table). The parameters for the waveguide 208 in the coaxial LiDAR system were: W1=700 nm, W2=150 nm, and L=300 μm, using a SiN waveguide with a thickness of 400 nm.

The signal amplitude of the coaxial LiDAR system was 50.6 dB. The signal amplitude of the dual-port system changed depending on the waveguide separation D. Among the data points, when the separation was about 7 μm, the amplitude was the highest (49.43 dB, or 1.17 dB lower than coaxial transceiver). When the separation was smaller than 5 μm or larger than 10 μm, the signal amplitude started to drop.

Thus, the preferable waveguide spacing D is approximately 5 to 10 μm, or more preferably, approximately 7 μm. More generally, for commonly used waveguide fabrication platforms, waveguide spacing D between 4 μm to 20 μm are acceptable, although the performance may start to drop at the two ends of this range.

As mentioned earlier, the two waveguides of the dual-port transceiver are preferably identical in shape and dimensions and disposed parallel to each other, but this is not required. The tapering sections 102 are preferably straight without any bend, in order to perform mode matching with minimum reflection. The wider waveguide sections 100 may be bent for purposes of coupling to other waveguides on the chip, but at least the segments that are joined to the tapering sections 102 are straight and parallel to each other. It is also possible, although less preferred, for the two narrower waveguide sections 103 to have bends, or be non-parallel to each other for their entire lengths or parts thereof. In such cases, the waveguide spacing D will refer to the distance between the two ends 101 of the narrower waveguide sections 103 at the edge of the PIC chip where light signals are coupled between the waveguides and space.

It will be apparent to those skilled in the art that various modification and variations can be made in the dual-port optical transceiver of the present invention without departing from the spirit or scope of the invention. Thus, it is intended that the present invention cover modifications and variations that come within the scope of the appended claims and their equivalents.

1. A dual-port optical transceiver for a light detection and ranging (LiDAR) system, comprising:
a substrate;
a first waveguide disposed on the substrate, the first waveguide having a first section with a first width, a second section with a second width smaller than the first width, and a tapering section connecting the first section and the second section, wherein an end of the second section is located on an edge of the substrate; and
a second waveguide disposed on the substrate, the second waveguide having a first section with a first width, a second section with a second width smaller than the first width, and a tapering section connecting the first section and the second section, wherein an end of the second section is located on the edge of the substrate;
wherein a waveguide spacing between the first waveguide and the second waveguide is between 4 μm and 20 μm.

2. The dual-port optical transceiver of claim 1, wherein the first and second waveguides are parallel to each other.

3. The dual-port optical transceiver of claim 1, wherein the first and second waveguides are formed of silicon, silicon nitride, or indium phosphide.

4. A light detection and ranging (LiDAR) system, comprising:
the dual-port optical transceiver of claim 1;
a light source;
a power beam slitter having an input port optically coupled to the light source and a first output port optically coupled to an end of the first section of the first waveguide;
a photonic mixer having a second input port optically coupled to an end of the first section of the second waveguide;
a delay line optically coupled between a second output port of the power beam splitter and a first input port of the photonic mixer; and
two photodetectors forming a balanced photodetector, optically coupled to two output ports of the photonic mixer.

5. The LiDAR system of claim 4, wherein the beam slitter, the photonic mixer, and the balanced photodetector are disposed on the substrate to form a photonic integrated circuit along with the dual-port optical transceiver.

6. The LiDAR system of claim 4, further comprising:
a collimating lens optically coupled to the first ends of both the first and second waveguides; and
a beam steering mechanism optically coupled to the collimating lens.

7. The LiDAR system of claim 6, further comprising:
an amplifier electrically coupled to the balanced photodetector to generate amplified signals; and
electrical processing circuitry configured to control the beam steering mechanism and process the amplified signals.

8. A method for operating a light detection and ranging (LiDAR) system including a dual-port optical transceiver, comprising:
transmitting light through a first waveguide disposed on a substrate, wherein the first waveguide has a first section with a first width, a second section with a second width smaller than the first width, and a tapering section connecting the first section and the second section, wherein an end of the second section is located on an edge of the substrate for transmitting the light; and
receiving reflected light through a second waveguide disposed on the substrate, wherein the second waveguide has a first section with a first width, a second section with a second width smaller than the first width, and a tapering section connecting the first section and the second section, wherein an end of the second section is located on the edge of the substrate for receiving the reflected light, and
wherein a waveguide spacing between the first waveguide and the second waveguide is between 4 μm and 20 μm.

9. The method for operating the LiDAR system of claim 8, further comprising:
generating the light using a light source optically coupled to the first waveguide;
detecting the received light using a photodetector optically coupled to the second waveguide.

10. The method for operating the LiDAR system of claim 8, further comprising:
collimating the transmitted light from the end of the second section of the first waveguide using a collimating lens; and
focusing the reflected light into the end of second section of the second waveguide using the collimating lens.

11. The method for operating the LiDAR system of claim 10, further comprising:
steering the transmitted light and the reflected light using a beam steering mechanism.

12. The method for operating the LiDAR system of claim 11, wherein the light generated by the light source is pulsed light or continuous wave light, the method further comprising:
measuring a time-of-flight between the transmitted and received light pulses, or a modulated frequency shift between the transmitted and received continuous wave light;
calculating distance information based on the measured time-of-flight or the modulated frequency shift.

13. The method for operating the LiDAR system of claim 12, further comprising:
analyzing the received light to generate intensity information; and
generating a three-dimensional point cloud based on the distance and intensity information.

14. A method for manufacturing a light detection and ranging (LiDAR) system including a dual-port optical transceiver, comprising:
forming a first waveguide on a substrate, the first waveguide having a first section with a first width, a second section with a second width smaller than the first width, and a tapering section connecting the first section and the second section, wherein an end of the second section is located on an edge of the substrate; and
forming a second waveguide on the substrate, the second waveguide having a first section with a first width, a second section with a second width smaller than the first width, and a tapering section connecting the first section and the second section, wherein an end of the second section is located on the edge of the substrate;
wherein a waveguide spacing between the first waveguide and the second waveguide is between 4 μm and 20 μm.

15. The method for manufacturing the LiDAR system of claim 14, wherein the first and second waveguides are parallel to each other.

16. The method for manufacturing the LiDAR system of claim 14, wherein the first and second waveguides are formed of silicon, silicon nitride, or indium phosphide.

17. The method for manufacturing the LiDAR system of claim 14, further comprising:
optically coupling a light source to the first waveguide; and
optically coupling a balanced photodetector to the second waveguide.

18. The method for manufacturing the LiDAR system of claim 14, further comprising:
providing a light source;
forming a power beam slitter having an input port optically coupled to the light source and a first output port optically coupled to an end of the first section of the first waveguide;
forming a photonic mixer having a first input port optically coupled to an end of the first section of the second waveguide;
forming a delay line optically coupled between a second output port of the power beam splitter and a second input port of the photonic mixer; and
forming a balanced photodetector including two photodetectors, optically coupled to two output ports of the photonic mixer.

19. The method for manufacturing the LiDAR system of claim 18, wherein the beam slitter, the photonic mixer, and the balanced photodetector are disposed on the substrate to form a photonic integrated circuit along with the first and second waveguides.
